(19) United States
(12) Patent Application Publication
(10) Pub. No.: US 2026/0014050 A1
(43) Pub. Date: Jan. 15, 2026

(54) PHYSICAL THERAPY DEVICE

(71) Applicant: LG ELECTRONICS INC., Seoul (KR)

(72) Inventors: Seungyoon SHIN, Seoul (KR); Yongju YANG, Seoul (KR); Gyuseog HONG, Seoul (KR); Suwon SEO, Seoul (KR); Munseong KANG, Seoul (KR); Sangwon KIM, Seoul (KR); Dongwon KIM, Seoul (KR)

(73) Assignee: LG ELECTRONICS INC., Seoul (KR)

(21) Appl. No.: 18/994,441

(22) PCT Filed: Jul. 29, 2022
(86) PCT No.: PCT/KR2022/011224

§ 371 Date: Jan. 14, 2025

(51) Int. Cl. A61H 23/02

(52) U.S. Cl. CPC A61H 23/0245; A61H 2201/1207; A61H 2205/102

(57) ABSTRACT

A physical therapy device comprises: a flexible printed circuit board; a plurality of vibrators electrically connected to the flexible printed circuit board; SUS caps that cover upper surfaces of each of the plurality of vibrators; silicone covers that cover the flexible printed circuit board, the plurality of vibrators, and the SUS caps; a hydrogel that is removed from the back surface of the silicone cover; and a control unit that is connected to the flexible printed circuit board to supply current to the plurality of vibrators, wherein the back surface of the silicone cover is polished to high brightness. The physical therapy device enables ultrasonic waves generated by the plurality of vibrators to penetrate into a body contact area by means of the removable hydrogel without using a gel for ultrasonic injection, and enables the ultrasonic waves to be uniformly transmitted to the body contact area by polishing the back surface of the silicone from which the hydrogel is removed to high brightness to increase adhesion with the hydrogel.

### CROSS REFERENCE TO RELATED APPLICATIONS

This application is the National Phase of PCT International Application No. PCT/KR2022/011224, filed on Jul. 29, 2022, which is hereby expressly incorporated by reference into the present application.

### TECHNICAL FIELD

The present disclosure relates to a physical therapy device for transmitting ultrasonic waves generated by a plurality of oscillators to a body contact area through a hydrogel.

### BACKGROUND ART

In general, physical therapy devices, such as an ultrasonic therapy device, a low frequency therapy device, and an electric potential therapy device, are known. Thereamong, the ultrasonic therapy device has been widely used for musculoskeletal diseases, muscle pain relief, and the like, and recently, the ultrasonic therapy device has been used to treat degenerative arthritis by directly affecting the activation of chondrocytes by applying ultrasonic waves to the joint area.

The ultrasonic therapy device includes a plurality of oscillators configured to generate ultrasonic waves in order to provide vibration to a body contact area, a member having the oscillators arranged thereon, the member being configured to wrap around the body contact area, and a power supply configured to supply power.

Meanwhile, the ultrasonic waves generated by the oscillators have the characteristic of being reflected or dissipated when coming into contact with air, and therefore the therapeutic effect using ultrasonic waves is very low if the ultrasonic therapy device is not in direct contact with the body.

In addition, an ultrasonic input gel used for the ultrasonic waves generated by the oscillators to penetrate the body contact area is not fixed to the body and flows off, resulting in the problem that the ultrasonic waves penetrate the body contact area only through the area where the ultrasonic input gel remains, whereby the therapeutic effect using ultrasonic waves is reduced.

Furthermore, when the ultrasonic input gel is used, it is necessary to clean the ultrasonic therapy device after use, which is inconvenient.

### DISCLOSURE

### Technical Task

The present disclosure provides a physical therapy device, and more particularly, it is an object of the present disclosure to provide a physical therapy device that allows ultrasonic waves generated by a plurality of oscillators to penetrate a body contact area through a detachable hydrogel without using an ultrasonic input gel, wherein a rear surface of silicone to which the hydrogel is detachably attached is high-gloss polished in order to increase the adhesion to the hydrogel such that the ultrasonic waves can be uniformly transmitted to the body contact area.

### Technical Solutions

The present disclosure provides a physical therapy device including a flexible circuit board, a plurality of oscillators electrically connected to the flexible circuit board, an SUS cap configured to cover an upper surface of each of the plurality of oscillators, a silicone cover configured to cover the flexible circuit board, the plurality of oscillators, and the SUS cap, a hydrogel detachably attached to a rear surface of the silicone cover, and a controller connected to the flexible circuit board, the controller being configured to supply current to the plurality of oscillators, wherein the rear surface of the silicone cover is high-gloss polished.

The rear surface of the silicone cover may be high-gloss polished after the silicone cover is formed by hot pressing using a mold.

The hydrogel may have at least one bending slit extending from the periphery thereof.

The SUS cap may have a bonding layer that abuts the upper surface of the oscillator, and may be spaced apart from the side of the oscillator.

The plurality of oscillators may be disposed in a polygonal shape.

The plurality of oscillators may be disposed in a triangular shape on each side of the controller.

The plurality of oscillators may be disposed in line in a longitudinal direction of the flexible circuit board while being spaced apart from each other.

The plurality of oscillators may be spaced apart from each other by different distances.

The silicone cover may have a thickness of 0.1 mm to 2 mm.

### Advantageous Effects

A physical therapy device according to the present disclosure allows ultrasonic waves generated by a plurality of oscillators to penetrate a body contact area through a detachable hydrogel without using an ultrasonic input gel, wherein a rear surface of silicone to which the hydrogel is detachably attached is high-gloss polished in order to increase the adhesion to the hydrogel such that the ultrasonic waves can be uniformly transmitted to the body contact area.

In addition, a bending slit may be formed in the hydrogel, whereby the adhesion of the hydrogel may be increased and the restriction of user's movement may be minimized even when attached to a curved body contact area such as the knee.

In addition, the plurality of oscillators may be disposed differently depending on the body contact area, whereby it is possible to improve the therapeutic effect using ultrasonic waves.

Further scope of applicability of the present disclosure will become apparent from the following detailed description. However, various changes and modifications within the spirit and scope of the present disclosure will be clearly understood by those skilled in the art, and therefore the detailed description and a specific embodiment, such as a preferred embodiment of the present disclosure, should be understood as being given by way of example only.

### DESCRIPTION OF DRAWINGS

FIG. 1 is a perspective view showing a physical therapy device according to an embodiment of the present disclosure.

FIG. 2 is a side view of the physical therapy device according to the embodiment of the present disclosure.

FIG. 3 is an exploded perspective view of the physical therapy device according to the embodiment of the present disclosure.

FIG. 4 is a view illustrating double insert molding of a silicone cover in the physical therapy device according to the embodiment of the present disclosure.

FIG. 5 is a view showing a high-gloss polished rear surface of the silicone cover of the physical therapy device according to the embodiment of the present disclosure.

FIG. 6 is a view showing a bending slit formed in a hydrogel of the physical therapy device according to the embodiment of the present disclosure.

FIG. 7 is a view showing an SUS cap covering an upper surface of an oscillator in the physical therapy device according to the embodiment of the present disclosure.

FIG. 8 is a view showing the layout of a plurality of oscillators in the physical therapy device according to the embodiment of the present disclosure.

FIG. 9 is a view showing another embodiment of the layout of the plurality of oscillators in the physical therapy device of the present disclosure.

FIG. 10 shows measurement data of ultrasonic waves superimposed according to the distance between the plurality of oscillators in the physical therapy device according to the embodiment of the present disclosure.

FIG. 11 is a view showing the form in which the plurality of oscillators is disposed in line in the physical therapy device according to the embodiment of the present disclosure.

### BEST MODE FOR DISCLOSURE

Description will now be given in detail according to exemplary embodiments disclosed herein, with reference to the accompanying drawings. The same or equivalent components may be provided with the same reference numbers, and description thereof will not be repeated. As used herein, the suffixes “module” and “part” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, it will be understood that when an element is referred to as being “directly connected with” another element, there are no intervening elements present.

A singular representation may include a plural representation unless it represents a definitely different meaning from the context.

The terms such as “include” or “have” used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

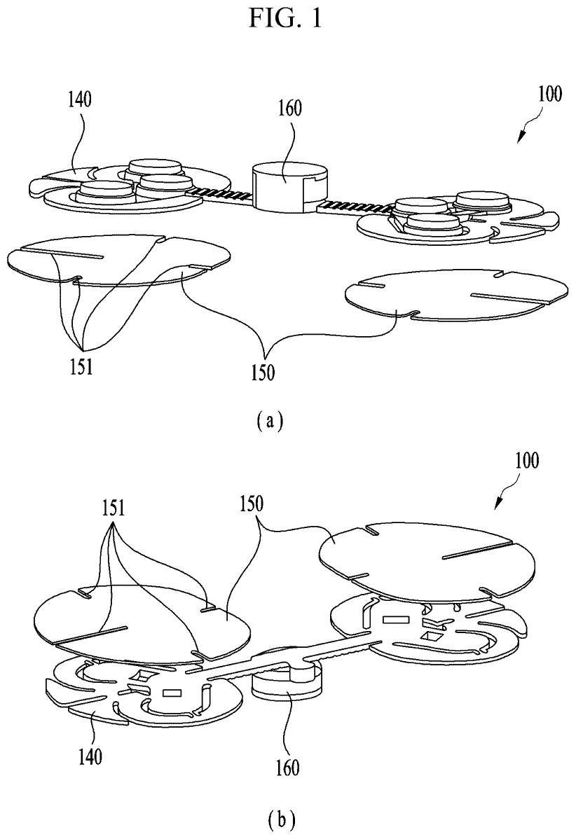

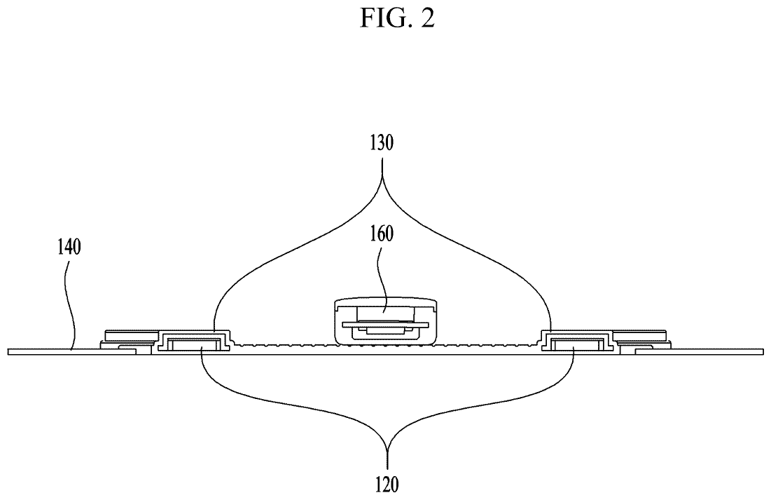

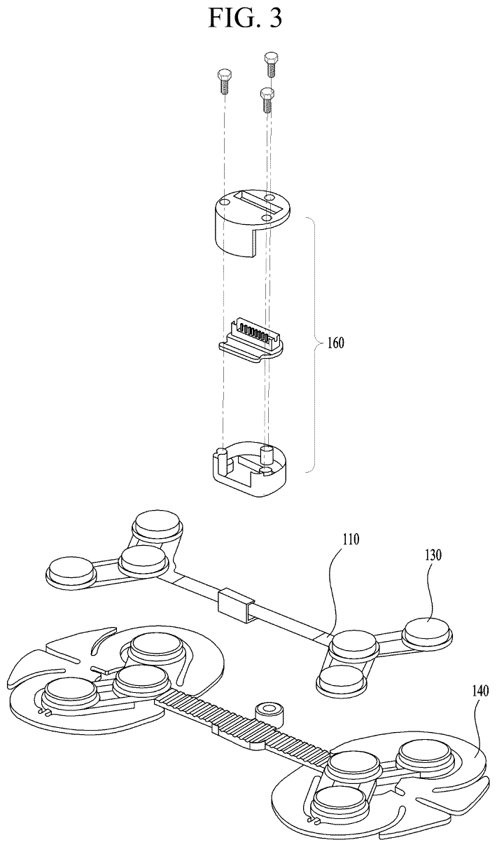

FIG. 1 is a perspective view showing a physical therapy device 100 according to an embodiment of the present disclosure. FIG. 2 is a side view of the physical therapy device 100 according to the embodiment of the present disclosure, and FIG. 3 is an exploded perspective view of the physical therapy device 100 according to the embodiment of the present disclosure.

The physical therapy device 100 of the present disclosure includes a flexible circuit board 110, a plurality of oscillators 120, an SUS cap 130, a silicone cover 140, a hydrogel 150, and a controller 160.

The plurality of oscillators 120 is electrically connected to the flexible circuit board 110, and the SUS cap 130 covers an upper surface of each of the plurality of oscillators 120. The silicone cover 140 covers the flexible circuit board 110, the plurality of oscillators 120, and the SUS cap 130.

The hydrogel 150 serves to allow ultrasonic waves generated by the plurality of oscillators 120 to penetrate a body contact area, and is detachably attached to a rear surface of the silicone cover 140. The controller 160 is connected to the flexible circuit board 110 to supply current to the plurality of oscillators 120. In particular, the rear surface of the silicone cover 140, to which the hydrogel 150 is detachably attached, is high-gloss polished.

In addition, the silicone cover 140 may have a thickness of 0.1 mm to 2 mm, taking into account durability and efficiency of ultrasound transmission.

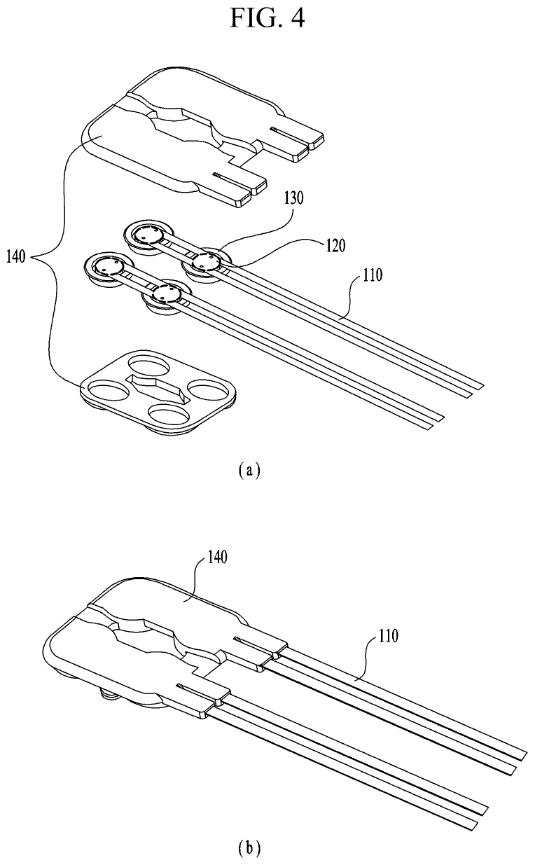

FIG. 4 is a view illustrating double insert molding of the silicone cover 140 in the physical therapy device 100 according to the embodiment of the present disclosure.

The silicone cover 140 is formed by hot pressing using a mold, and, the silicone cover 140 covers the flexible circuit board 110, the plurality of oscillators 120, and the SUS cap 130 by double insert molding. At this time, the adhesion of the silicone cover 140 to the flexible circuit board 110, the plurality of oscillators 120, and the SUS cap 130 may be performed using a primer.

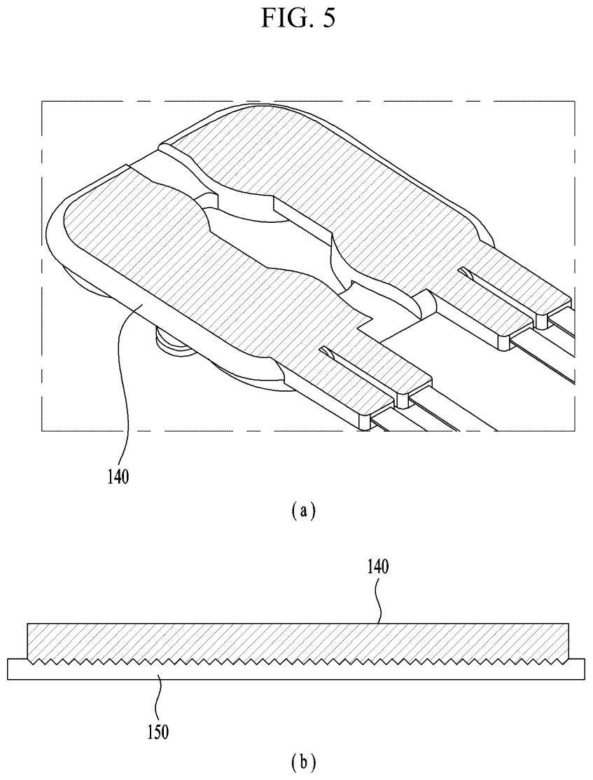

FIG. 5 is a view showing a high-gloss polished rear surface of the silicone cover 140 of the physical therapy device 100 according to the embodiment of the present disclosure.

FIG. 5(a) is a view showing the high-gloss polished rear surface of the silicone cover 140 when viewed from below, and FIG. 5(b) is a view showing that the hydrogel 150 is attached to the high-gloss polished rear surface of the silicone cover 140.

The physical therapy device 100 according to the present disclosure has a structure in which the hydrogel 150 is detachably attached to the rear surface of the silicone cover 140 without using an ultrasonic input gel. Since ultrasonic waves are reflected or dissipated when coming into contact with air, it is necessary to increase the adhesion between the rear surface of the silicone cover 140 and the hydrogel 150 such that there is no air layer between the rear surface of the silicone cover 140 and the hydrogel 150 in order to increase the therapeutic effect using ultrasonic waves.

In order to increase the adhesion to the hydrogel 150, it is necessary to ensure that the rear surface of the silicone cover 140 has a certain roughness rather than being flat. In the physical therapy device 100 of the present disclosure, therefore, the rear surface of the silicone cover 140 may be coated with a coating agent for surface treatment by high-gloss polishing in order to increase the adhesion to the hydrogel 150.

Referring to FIG. 5(b), the high-gloss polished rear surface of the silicone cover 140 has a certain roughness due to the formation of fine protrusions. This may increase the adhesion between the rear surface of the silicone cover 140 and the hydrogel 150, allowing ultrasonic waves to be transmitted to the body contact area without encountering air.

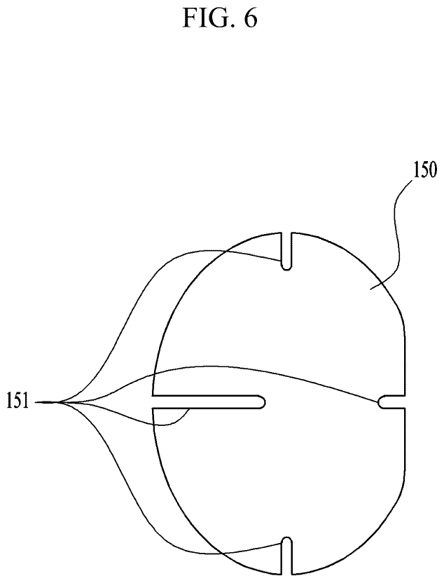

FIG. 6 is a view showing a bending slit formed in the hydrogel 150 of the physical therapy device 100 according to the embodiment of the present disclosure.

Conventionally, an ultrasonic input gel is used for ultrasonic waves to penetrate the body contact area, but the ultrasonic input gel is not fixed to the body and flows off, resulting in the problem that ultrasonic waves penetrate only the area where the ultrasonic input gel remains, whereby the therapeutic effect is reduced.

In the physical therapy device 100 according to the present disclosure, it is possible for ultrasonic waves to pass through the hydrogel 150 that is attached to the user's body without using the ultrasonic input gel. In addition, the hydrogel 150 may have at least one bending slit 151 extending from the periphery thereof, which may improve the flexibility of the hydrogel 150.

Even when attached to a curved body contact area such as the knee, therefore, the adhesion of the hydrogel may be increased to ensure uniform transmission of ultrasonic waves, and the restriction of movement may be minimized even in the state in which the physical therapy device 100 according to the present disclosure is attached to the user. Furthermore, since no ultrasonic input gel is used, there is no need for separate cleaning after treatment.

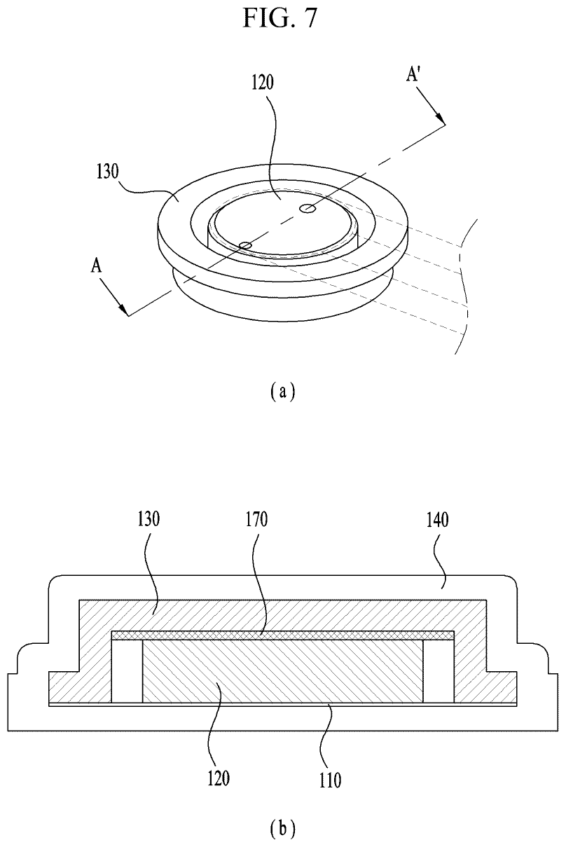

FIG. 7 is a view showing the SUS cap 130 covering the upper surface of the oscillator 120 in the physical therapy device 100 according to the embodiment of the present disclosure.

FIG. 7(a) is a bottom view of the SUS cap 130 covering the upper surface of the oscillator 120, and FIG. 7(b) is an A-A′ sectional view of FIG. 7(a).

The SUS cap 130 has a bonding layer 170 that abuts the upper surface of the oscillator 120, and is spaced apart from the side of the oscillator 120. The silicone cover 140 covers the flexible circuit board 110, the oscillator 120, and the SUS cap 130.

Referring to FIG. 7(b), the SUS cap 130 is spaced apart from the side of the oscillator 120, and has a bonding layer 170 that abuts the upper surface of the oscillator 120.

In order to enhance the therapeutic effect using ultrasonic waves, ultrasonic waves generated by the oscillator 120 must be focused onto the body contact area. To this end, the SUS cap 130 is provided with a bonding layer 170 that abuts the upper surface of the oscillator 120 such that some of the ultrasonic waves generated by the oscillator 120 that are directed to the opposite side of the body contact area can be reflected to the body contact area. The bonding layer 170 may be made of thin silicone.

Furthermore, the SUS cap 130 may also serve as a heat dissipation member in order to prevent heat generated by the plurality of oscillators 120 from being released to the outside.

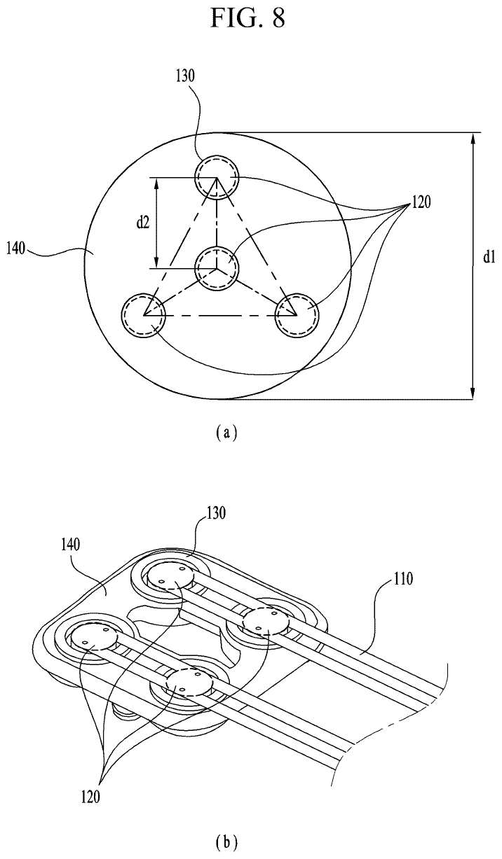

FIG. 8 is a view showing the layout of the plurality of oscillators 120 in the physical therapy device 100 according to the embodiment of the present disclosure.

FIG. 8(a) is a view showing the form in which the plurality of oscillators 120 is disposed in an equilateral triangular shape, and FIG. 8(b) is a view showing the form in which the plurality of oscillators is disposed in a quadrangular shape. This is the layout of the plurality of oscillators 120 for relieving muscle pain, such as back or lower back pain.

When the physical therapy device 100 is used to relieve muscle pain, it is necessary to ensure that ultrasonic waves generated by the plurality of oscillators 120 are evenly distributed over a large treatment area.

Referring to FIG. 8(a), the diameter d1 of the circular cylinder cover 140 may be 85 mm in consideration of ease of use. One oscillator 120 may be disposed in the center of the circular cylinder cover 140, and three oscillators 120 may be disposed in an equilateral triangle shape while having a distance d2 of 30 mm therefrom.

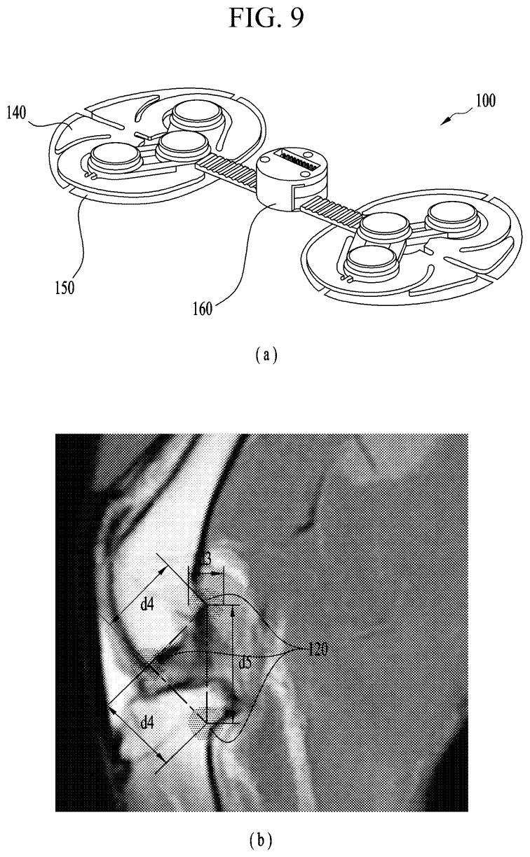

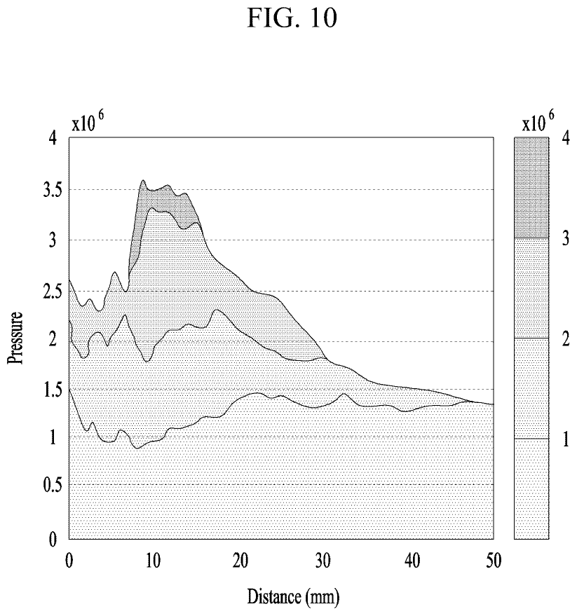

FIG. 9 is a view showing another embodiment of the layout of the plurality of oscillators 120 in the physical therapy device 100 of the present disclosure, and FIG. 10 shows measurement data of ultrasonic waves superimposed according to the distance between the plurality of oscillators 120 in the physical therapy device 100 according to the embodiment of the present disclosure.

FIG. 9(a) is a view showing the form in which the plurality of oscillators 120 is disposed in a triangular shape on each side of the controller 160. In this case, the physical therapy device 100 may be attached to the knee and used to treat arthritis. The controller 160 is located at the front of the knee, and the plurality of oscillators 120 disposed in a triangular shape on each side of the controller 160 is located on each side of the knee. FIG. 9(b) is a view showing the plurality of oscillators 120 disposed in a triangular shape on one side of the knee.

In order to increase the therapeutic effect by ultrasonic waves, ultrasonic waves generated by the plurality of oscillators 120 must be intensively transmitted to the cartilage in the knee. If the plurality of oscillators 120 is disposed at large intervals or if the plurality of oscillators is disposed at small intervals, the ultrasonic waves may not be intensively transmitted to the cartilage.

Referring to FIG. 10 illustrating this, it can be seen that, if the diameter of each of the plurality of oscillators 120 is 9 mm to 20 mm, ultrasonic waves are superimposed the most when the distance between the plurality of oscillators 120 is 9 mm to 20 mm.

In order to treat the arthritis of the knee, therefore, the plurality of oscillators 120 may be disposed in a triangular shape such that the diameter d3 of each of the plurality of oscillators 120 is 9 mm to 20 mm and the distances d4 and d5 between the plurality of oscillators 120 are 9 mm to 20 mm, as shown in FIG. 9. In this case, ultrasonic waves generated by the plurality of oscillators 120 may be intensively transmitted to the cartilage in the knee, thereby improving the knee arthritis treatment effect by ultrasonic waves.

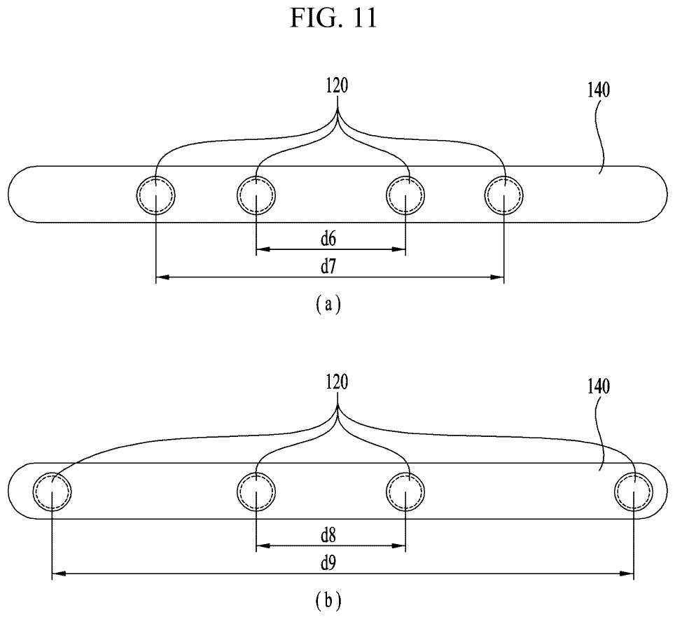

FIG. 11 is a view showing the form in which the plurality of oscillators 120 is disposed in line in the physical therapy device 100 according to the embodiment of the present disclosure.

FIG. 11(a) is a view showing the form in which the plurality of oscillators 120 is disposed in line while being spaced apart from each other in order to treat the arthritis of the wrist, and FIG. 11(b) is a view showing the form in which the plurality of oscillators 120 is disposed in line while being spaced apart from each other in order to treat the arthritis of the ankle.

The thickness of the ankle is greater than the thickness of the wrist, and the position of the cartilage is different accordingly. In consideration of this, it is necessary to dispose the plurality of oscillators 120 for treating the arthritis of the wrist and the ankle at different intervals.

For example, in the case of FIG. 11(a), the distance d6 between two oscillators 120 located on the inside may be 50 mm and the distance d7 between two oscillators 120 located on the outside may be 120 mm for treatment of the arthritis of the wrist.

In the case of FIG. 11(b), the distance d8 between two oscillators 120 located on the inside may be 50 mm and the distance d9 between two oscillators 120 located on the outside may be 210 mm for treatment of the arthritis of the ankle.

The above detailed description is to be construed in all aspects as illustrative and not restrictive. The scope of the present disclosure should be determined by reasonable interpretation of the appended claims and all changes coming within the equivalency range of the present disclosure are intended to be embraced in the scope of the present disclosure.

What is claimed is:

1. A physical therapy device comprising:
a flexible circuit board;
a plurality of oscillators electrically connected to the flexible circuit board;
an SUS cap configured to cover an upper surface of each of the plurality of oscillators;
a silicone cover configured to cover the flexible circuit board, the plurality of oscillators, and the SUS cap;
a hydrogel detachably attached to a rear surface of the silicone cover; and
a controller connected to the flexible circuit board, the controller being configured to supply current to the plurality of oscillators, wherein
the rear surface of the silicone cover is high-gloss polished.

2. The physical therapy device of claim 1, wherein the rear surface of the silicone cover is high-gloss polished after the silicone cover is formed by hot pressing using a mold.

3. The physical therapy device of claim 1, wherein the hydrogel has at least one bending slit extending from a periphery thereof.

4. The physical therapy device of claim 1, wherein the SUS cap has a bonding layer that abuts the upper surface of the oscillator, and is spaced apart from a side of the oscillator.

5. The physical therapy device of claim 1, wherein the plurality of oscillators is disposed in a polygonal shape.

6. The physical therapy device of claim 5, wherein the plurality of oscillators is disposed in a triangular shape on each side of the controller.

7. The physical therapy device of claim 1, wherein the plurality of oscillators is disposed in line in a longitudinal direction of the flexible circuit board while being spaced apart from each other.

8. The physical therapy device of claim 7, wherein the plurality of oscillators is spaced apart from each other by different distances.

9. The physical therapy device of claim 1, wherein the silicone cover has a thickness of 0.1 mm to 2 mm.
